(19) United States
(12) Patent Application Publication
(10) Pub. No.: US 2013/0002587 A1
(43) Pub. Date: Jan. 3, 2013

(54) HAPTIC APPARATUS AND TECHNIQUES FOR QUANTIFYING CAPABILITY THEREOF

(76) Inventors: Silmon James Biggs, Los Gatos, CA (US); Roger N. Hitchcock, San Leandro, CA (US)

(21) Appl. No.: 13/578,833

(22) PCT Filed: Feb. 15, 2011
(86) PCT No.: PCT/US2011/000289

§ 371 Date: Sep. 13, 2012

Related U.S. Application Data
(60) Provisional application No. 61/338,315, filed on Feb. 16, 2010.

(51) Int. Cl. G06F 3/041

(52) U.S. Cl. 345/173

(57) ABSTRACT

A computer-implemented method of quantifying the capability of a haptic system. The haptic system comprises an actuator. The computer comprises a processor, a memory, and an input/output interface for receiving and transmitting information to and from the processor. The computer provides an environment for simulating the mechanics of the haptic system, determining the performance of the haptic system, and determining a user sensation produced by the haptic system in response to an input to the haptic system. In accordance with the computer-implemented method, an input command is received by a mechanical system module that simulates a haptic system where the input command represents an input pressure applied to the haptic system. A displacement is produced by the mechanical system module in response to the input command. The displacement is received by an intensity perception module. The displacement is mapped to a sensation experienced by a user by the intensity perception module and the sensation experienced by the user in response to the input command is produced.

### CROSS REFERENCE TO RELATED APPLICATION

This application claims the benefit, under 35 USC §119(e), of U.S. provisional patent application No. 61/338,315, filed Feb. 16, 2010, entitled “ARTIFICIAL MUSCLE ACTUATORS FOR HAPTIC DISPLAYS: SYSTEM DESIGN TO MATCH THE DYNAMICS AND TACTILE SENSITIVITY OF THE HUMAN FINGERPAD,” the entire disclosure of which is hereby incorporated by reference.

### BACKGROUND OF THE INVENTION

In one aspect, the present disclosure relates generally to a haptic apparatus and techniques for quantifying the capability of the haptic apparatus. More specifically, the present disclosure relates to a segmented haptic apparatus and a computer-implemented technique for determining the performance of the haptic apparatus.

Electroactive Polymer Artificial Muscles (EPAM™) based on dielectric elastomers have the bandwidth and the energy density required to make haptic displays that are both responsive and compact. Such EPAM™ based dielectric elastomers may be configured into thin, high-fidelity haptic modules for use in mobile handsets to provide a brief tactile “click” that confirms key press, and the steady state “bass” effects that enhance gaming and music. Design of haptic modules with such capabilities may be improved by modeling the physical system in a computer to enable prediction of the behavior of the system from a set of parameters and initial conditions. The output of the model may be passed through a transfer function to convert vibration into an estimate of the intensity of the haptic sensation that would be experienced by a user. Conventional computer models, however, do not adequately predict the behavior of a physical system configured into thin, high-fidelity haptic modules for use in mobile handsets to provide a brief tactile “click” that confirms key press, and a steady state “bass” effect that enhances gaming and music activities.

### SUMMARY OF THE INVENTION

In one aspect, a computer-implemented method of quantifying the capability of a haptic system is provided. The haptic system comprises an actuator. The computer comprises a processor, a memory, and an input/output interface for receiving and transmitting information to and from the processor. The computer provides an environment for simulating the mechanics of the haptic system, determining the performance of the haptic system, and determining a user sensation produced by the haptic system in response to an input to the haptic system. The computer-implemented method comprises receiving an input command by a mechanical system module that simulates a haptic system, wherein the input command represents an input voltage applied to the haptic system; producing a displacement by the mechanical system module in response to the input command; receiving the displacement by an intensity perception module; mapping the displacement to a sensation experienced by a user by the intensity perception module; and producing the sensation experienced by the user in response to the input command.

### BRIEF DESCRIPTION OF THE FIGURES

The present invention will now be described for purposes of illustration and not limitation in conjunction with the figures, wherein:

FIG. 1 is a cutaway view of a haptic system;

FIG. 2A is a diagram of a system for quantifying the performance of a haptic module that provides suitable capability for gaming/music and click applications;

FIG. 2B is a functional block diagram of the system shown in FIG. 2A;

FIG. 3A is a mechanical system model of the actuator mechanical system shown in FIGS. 2A-B;

FIG. 3B illustrates a performance model of an actuator;

FIG. 4A illustrates one aspect of a flexure-stage system to measure finger impedance;

FIG. 4B is a graphical representation of data of data obtained using the flexure-stage system of FIG. 4A with and without 1 N finger contact (points) fit to a second order model (lines);

FIG. 5A is a graphical representation of best-fit spring parameters for the fingertips of six subjects;

FIG. 5B is a graphical representation of best-fit damping parameters for the fingertips of six subjects;

FIG. 6A is a top view showing a test setup for measuring impedance of the palm;

FIG. 6B is a graphical representation of spring rate and damping of users' palms in multiple grasps;

FIG. 7A illustrates one aspect of a segmented actuator configured in a bar array geometry;

FIG. 7B is a side view of the segmented actuator shown in FIG. 7A that illustrates one aspect of an electrical arrangement of the phases with respect to the frame and bars elements of the actuator;

FIG. 7C is a side view illustrating the mechanical coupling of the frame to a backplane and the bars to an output plate;

FIG. 7D illustrates a segmented electrode with a seven-segment footprint;

FIG. 7E illustrates a segmented electrode with a six-segment footprint;

FIG. 7F illustrates a segmented electrode with a five-segment footprint;

FIG. 7G illustrates a segmented electrode with a four-segment footprint;

FIG. 8A is a graphical representation of strain energy versus displacement of a symmetrical actuator calculated for dielectric on one side of the actuator where strain energy in Joules (J) is shown along the vertical axis and displacement in meters (m) is shown along the horizontal axis;

FIG. 8B is a graphical representation of elastic forces versus displacement of a symmetrical actuator calculated where force in Newtons (N) is shown along the vertical axis and displacement in meters (m) is shown along the horizontal axis;

FIG. 8C is a graphical representation of voltage versus displacement of a symmetrical actuator where Voltage (V) is shown along the vertical axis and displacement, x, in meters (m) is shown along the horizontal axis;

FIG. 9 is a graphical representation of sensation level predicted from displacement and frequency;

FIG. 10A is a graphical representation of predicted steady state amplitude associated with segmenting the footprint into (n) regions, where n=1 . . . 10, (circles) for the palm;

FIG. 10B is a graphical representation of predicted steady state amplitude associated with segmenting the footprint into (n) regions, where n=1 . . . 10, (circles) for the fingertip;

FIG. 10C is a graphical representation of steady state sensations for the palm;

FIG. 10D is a graphical representation of steady state sensations for the fingertip;

FIG. 11A is a graphical representation of predicted click amplitude that a candidate module could provide in service for the palm and fingertip;

FIG. 11B is a graphical representation of predicted click sensation that a candidate module could provide in service for the palm and fingertip;

FIG. 12 is a graphical representation of steady state response of the module with a test mass was measured on the bench top, modeled (line) versus measured (points);

FIG. 13 is a graphical representation of observed click data for two users (points), and predictions of the model for an average user (lines);

FIG. 14A is a graphical representation of amplitude versus frequency for various competing haptic technologies;

FIG. 14B is a graphical representation of estimated sensation level versus frequency for various competing haptic technologies; and

FIG. 15 illustrates an example environment for implementing various aspects of the computer-implemented method for quantifying the capability of a haptic apparatus.

### DESCRIPTION OF THE INVENTION

The present disclosure provides various aspects of Electroactive Polymer Artificial Muscles (EPAM) based on dielectric elastomers that have the bandwidth and the energy density required to make haptic displays that are both responsive and compact.

Examples of Electroactive Polymer (EAP) devices and their applications are described in U.S. Pat. Nos. 7,394,282; 7,378,783; 7,368,862; 7,362,032; 7,320,457; 7,259,503; 7,233,097; 7,224,106; 7,211,937; 7,199,501; 7,166,953; 7,064,472; 7,062,055; 7,052,594; 7,049,732; 7,034,432; 6,940,221; 6,911,764; 6,891,317; 6,882,086; 6,876,135; 6,812,624; 6,809,462; 6,806,621; 6,781,284; 6,768,246; 6,707,236; 6,664,718; 6,628,040; 6,586,859; 6,583,533; 6,545,384; 6,543,110; 6,376,971 and 6,343,129; and in U.S. Published Patent Application Nos. 2009/0001855; 2009/0154053; 2008/0180875; 2008/0157631; 2008/0116764; 2008/0022517; 2007/0230222; 2007/0200468; 2007/0200467; 2007/0200466; 2007/0200457; 2007/0200454; 2007/0200453; 2007/0170822; 2006/0238079; 2006/0208610; 2006/0208609; and 2005/0157893, and U.S. patent application Ser. No. 12/358,142 filed on Jan. 22, 2009; PCT application No. PCT/US09/63307; and WO 2009/067708, the entireties of which are incorporated herein by reference.

In one aspect, the present disclosure provides thin, high-fidelity haptic modules for use in mobile handsets. The modules provide the brief tactile “click” that confirms key press, and the steady state “bass” effects that enhance gaming and music. In another aspect, the present disclosure provides computer-implemented techniques for modeling the physical haptic system to enable prediction of the behavior of the haptic system from a set of parameters and initial conditions. The model of the physical haptic system is comprised of an actuator, a handset, and a user. The output of the physical system is passed through a transfer function to convert vibration into an estimate of the intensity of the haptic sensation experienced by the user. A model of fingertip impedance versus button press force is calibrated to data, as is impedance of the palm holding a handset. An energy-based model of actuator performance is derived and calibrated, and the actuator geometry is tuned for good haptic performance.

In one aspect, the present disclosure is directed toward high-performance haptic modules configured for use in mobile handsets. The potential of dielectric elastomer actuators has been explored for other types of haptic displays, for example Braille, as described by Lee, S., Jung, K., Koo, J., Lee, S., Choi, H., Jeon, J., Nam, J. and Choi, H. in “Braille Display Device Using Soft Actuator,” Proceedings of SPIE 5385, 368-379 (2004), and wearable displays, as described by Bolzmacher, C., Biggs, J., Srinivasan, M. in “Flexible Dielectric Elastomer Actuators For Wearable Human-Machine Interfaces,” Proc. SPIE 6168, 27-38 (2006). The bandwidth and energy density of dielectric elastomers also make them an attractive technology for mobile handsets.

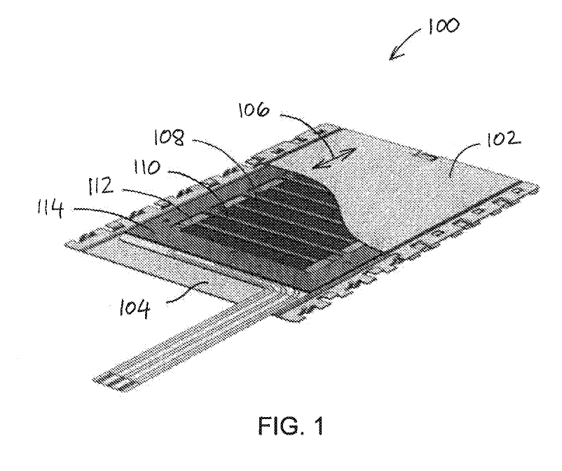

FIG. 1 is a cutaway view of a haptic system. The haptic system is now described with reference to the haptic module 100. The actuator slides an output plate 102 (e.g., sliding surface) relative to a fixed plate 104 (e.g., fixed surface). The plates 102, 104 are separated by steel bearings, and have features that constrain movement to the desired direction, limit travel, and withstand drop tests. For integration into a mobile handset, the top plate 102 is attached to an inertial mass or the touch screen and display. In the embodiment illustrated in FIG. 1, the top plate 102 of the haptic module 100 is comprised of a sliding surface that mounts to an inertial mass or back of a touch screen that can move bi-directionally as indicated by arrow 106. Between the output plate 102 and the fixed plate 104, the haptic module 100 comprises at least one electrode 108, at least one divider 110, and at least one bar 112 that attach to the sliding surface, e.g., the top plate 102. Frame and divider segments 114 attach to the fixed surface, e.g., the bottom plate 104. The haptic module 100 is representative of haptic modules developed by Artificial Muscle Inc. (AMI), of Sunnyvale, Calif.

Quantifying the Haptic Capability of a Module

Still with reference to FIG. 1, many of the design variables of the haptic module 100, (e.g., thickness, footprint) are fixed by the needs of module integrators, and others (e.g., number of dielectric layers, operating voltage) are constrained by cost. Since actuator geometry—the allocation of footprint to rigid supporting structure versus active dielectric—does not impact cost much, it is a reasonable way to tailor performance of the haptic module 100 to this application.

To gauge the merits of different actuator geometries, the present disclosure describes three models: (1) Mechanics of the Handset/User System; (2) Actuator Performance; and (3) User Sensation. Together, these three components provide a computer-implemented process for estimating the haptic capability of candidate designs and using the estimated haptic capability data to select a haptic design suitable for mass production. The model predicts the capability for two kinds of effects: long effects (gaming and music), and short effects (key clicks). “Capability” is defined herein as the maximum sensation a module can produce in service.

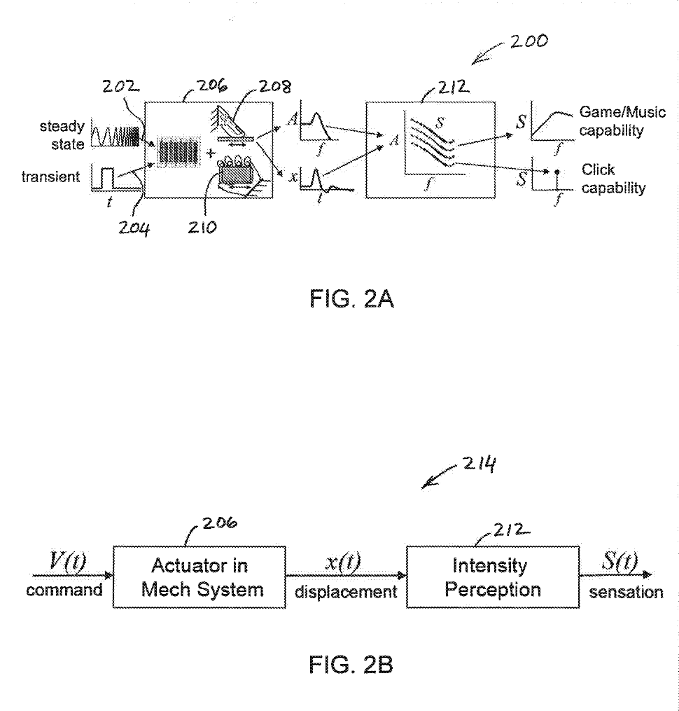

FIG. 2A is a diagram of a system 200 for quantifying the performance of a haptic module that provides suitable capability for gaming/music and click. As shown in FIG. 2A, the output of the system 200 is sensation (S) versus frequency (f) in response to a steady state input 202 and a transient input 204 into an actuator mechanical system module 206 simulating the haptic module 100 of FIG. 1. Functionally, the actuator mechanical system module 206 represents a fingertip portion 208 applying an input pressure to the haptic module 100 or a palm portion 210 squeezing the haptic module 100. Applying maximum voltage to the actuator 100 at different frequencies produces steady state amplitudes A(f) in the actuator mechanical system module 206 that a user will perceive as sensations S(f). An intensity perception module 212 maps displacement to sensation. These sensations S(f), which depend on frequency and amplitude, have intensities that can be expressed in decibels, and describe the gaming capability of a design. The click capability can be described in a similar way. The amplitude of a transient response x(t) to a pulse at full voltage is mapped to sensation in decibels. That sensation is the most intense “click” the design can produce in a single cycle. Since gaming capability leverages resonance, it can exceed click capability.

FIG. 2B is a functional block diagram 214 of the system 200. The sensation S(t) is produced in response to a steady state input command V(t). The actuator mechanical system module 206 produces a displacement x(t) in response to the input command V(t). The intensity perception module 212 maps the displacement input x(t) to sensation S(t).

In accordance with this approach, a model is constructed for quantifying capability of the haptic module 100. Also described is a calibration of the actuator mechanical system 206 in which the haptic module 100 works, which includes both the fingertip portion 208 and the palm portion 210. Sections on actuator performance cover a general-purpose model, and an actuator segmenting method that tunes performance to match the actuator mechanical system 206. Calibration of the sensation model to published data is also presented. The capability of the haptic module 100 versus actuator geometry is discussed. Performance of real modules compared to the model and to measurements of other technologies also are discussed hereinbelow.

One application of interest for this model is a hand held mobile device, with a haptic module that drives a touch screen laterally relative to the rest of the mobile device mass. A survey of a number of displays and touch screens in different mobile devices provides resulted in a movable mass average of approximately 25 grams and a remaining device mass of approximately 100 grams. These values represent a significant population of mobile devices but could easily be altered for other classes of consumer electronics (i.e., GPS systems, gaming systems).

Accounting for the Mechanics of the Handset and User

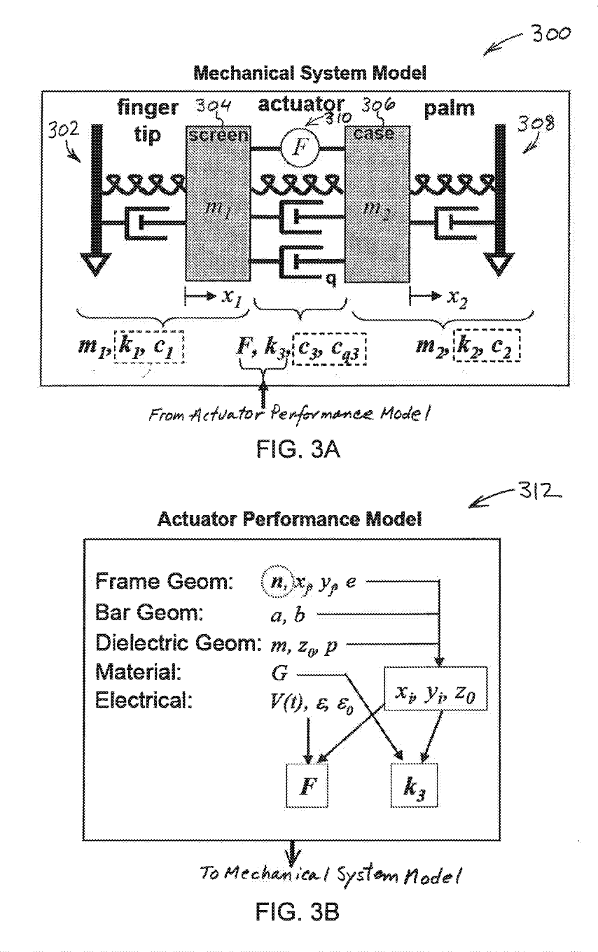

FIG. 3A is a mechanical system model 300 of the actuator mechanical system module 206 shown in FIGS. 2A-B. The actuator mechanical system 206 shown in FIGS. 2A-B is expanded. Dashed boxes indicate parameters of the fingertip 302, palm 308, and actuator 310 that were fit to data. In service, the haptic module 100 is part of a larger mechanical system that includes the fingertip 302, touchscreen 304, handset case 306, and palm 308. The mechanical system model 300 shows lumped elements that approximate this system and the actuator inside it. The fingertip 302 and palm 308 are treated as simple (m, k, c) mass-spring-damper systems. To estimate these parameters, the steady state response to proximal/distal shear vibration is measured at the index fingertip 302 during key press, and at the palm 308 holding a handset-sized mass. These measurements add data to the growing literature on haptic impedance, particularly tangential tractions on the skin where space constraints allow citation of only a few examples. Examples of such literatures includes, for example, Lundstrom, R., “Local Vibrations—Mechanical Impedance of the Human Hand's Glabrous Skin,” Journal of Biomechanics 17, 137-144 (1984); Hajian, A. Z. and Howe, R. D., “Identification of the mechanical impedance at the human finger tip,” ASME Journal of Biomechanical Engineering 119(1), 109-114 (1997); and Israr, A., Choi, S. and Tan, H. Z., “Mechanical Impedance of the Hand Holding a Spherical Tool at Threshold and Suprathreshold Stimulation Levels,” Proceedings of the Second Joint EuroHaptics Conference and Symposium on Haptic Interfaces for Virtual Environment and Teleoperator Systems, 55-60 (2007).

FIG. 3B illustrates a performance model 312 of the actuator 310. Actuator force (F) and spring rate (k₃) depend on the geometry (first nine parameters), shear modulus (G), and electrical properties. A geometry variable, n (dashed circle), represents a variable that may be varied during simulation, for example. The actuator 310 can be treated as a force source in parallel with a spring and damper. Adding an additional damper, this one quadratic (F=−c_{q3}v²), may improve calibration to measured performance. The geometry of the actuator 310 determines the blocked force and passive spring rate. A Neo-Hookean model describes the mechanics of the dielectric subjected to pre-stretch (p) with one free parameter, shear modulus (G), was calibrated to tensile stress/strain tests. An energy model yields a compact expression for force as function of actuator displacement and voltage. Segmenting the actuator into (n) sections allows the designers to trade off the available mechanical work between long free stroke and high blocked force, and also to adjust the resonant frequency of the overall system to match the needs of the haptic modules.

### Finger Model

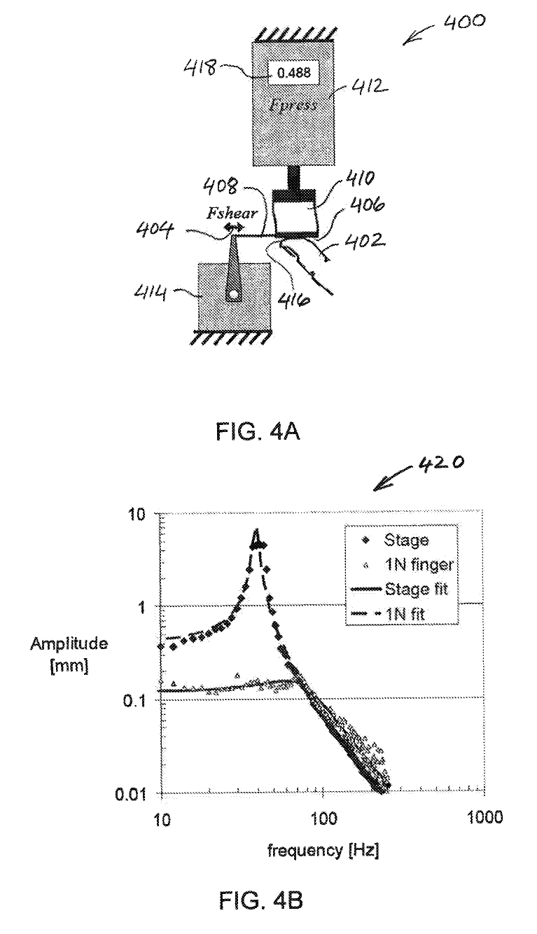

FIG. 4A illustrates one aspect of a flexure-stage system 400 to measure finger impedance. Since touchscreen interaction commonly involves the index finger 402, it is chosen for calibration. The test direction was distal/proximal shear as indicated by arrow 404 as subjects pressed a surface 406 with three different forces, {0.5, 1.0, 2.0} N, using the index finger 402. The subjects were all adults and included five men and one woman in total.

In one aspect, the index finger 402 may be treated as a single resonant mass/spring/damper system. The test fixture comprises a stage 408 on flexures 410, connected to a static force gage 412 in the vertical direction (e.g., Mecmesin, AFG 2.5 N MK4). A dynamic force source 414 with displacement monitoring is coupled to the stage 408 in the horizontal direction (e.g., Aurora Scientific, Model 305B). In one aspect, only normal variation during handset use is of interest and no attempt needs to be made to control the inclination of the tip 416 of the index finger 402. In other aspects, the inclination of the tip 416 of the index finger 402 may be controlled. During the test process, subjects simply need to pretend they are pressing a touchscreen. In one aspect, visual feedback from the static force gage 412 readout 418 can be used to keep finger force within 10% of the desired level while the dynamic force source drives the stage tangentially with a 0.1 N amplitude sine wave swept from 10 Hz to 250 Hz over about 30 seconds. Dynamic data may be recorded for each test.

The stage 408 can be driven with and without finger loads so that the mass, spring rate and damping can be fit to both loaded and unloaded data. In accordance with such an approach, the mass, spring rate, and damping of the stage 408 can be subtracted out from parameters estimated during the loaded condition, leaving only the contribution of the finger 402.

FIG. 4B is a graphical representation 420 of data obtained using the flexure-stage system of FIG. 4A with and without 1 N finger contact (points) fit to a second order model (lines). Amplitude in millimeters (mm) is shown along the vertical axis and Frequency in Hertz (Hz) is shown along the horizontal axis.

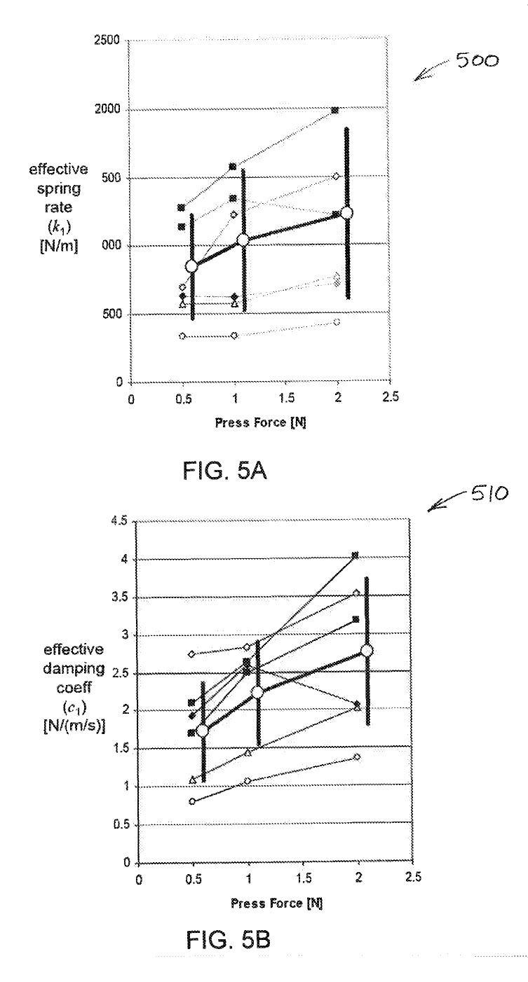

FIG. 5A is a graphical representation 500 of best-fit spring parameters for the fingertips of six subjects. Effective spring rate (k₁) in N/m is shown along the vertical axis and press force in N is shown along the horizontal axis. FIG. 5B is a graphical representation 510 of best-fit damping parameters for the fingertips of six subjects. Effective damping coefficient (c₁) in N/(m/s) is shown along the vertical axis and press force in N is shown along the horizontal axis. As shown in FIGS. 5A-B, average values are bracketed by lines marking +/−one standard deviation. After data collection, a solver can be used to estimate spring rate and a damping at each of the three touch forces and for each of the six test subjects. Apparent mass of the fingertip is within the noise, and too small to estimate in accordance with the described process. Variation between subjects is evident in spring rate and damping coefficient. On average, pressing harder increased both spring rate and damping.

TABLE 1 below provides average fingertip versus press force. The values provided in TABLE 1 are average values±one standard deviation.

TABLE 1

| | 0.5N | 1.0N | 2.0N |
|---|---|---|---|
| k₁ | 847 ± 378 | 1035 ± 510 | 1226 ± 619 |
| c₁ | 1.72 ± 0.64 | 2.23 ± 0.68 | 2.76 ± 0.95 |

### Palm Model

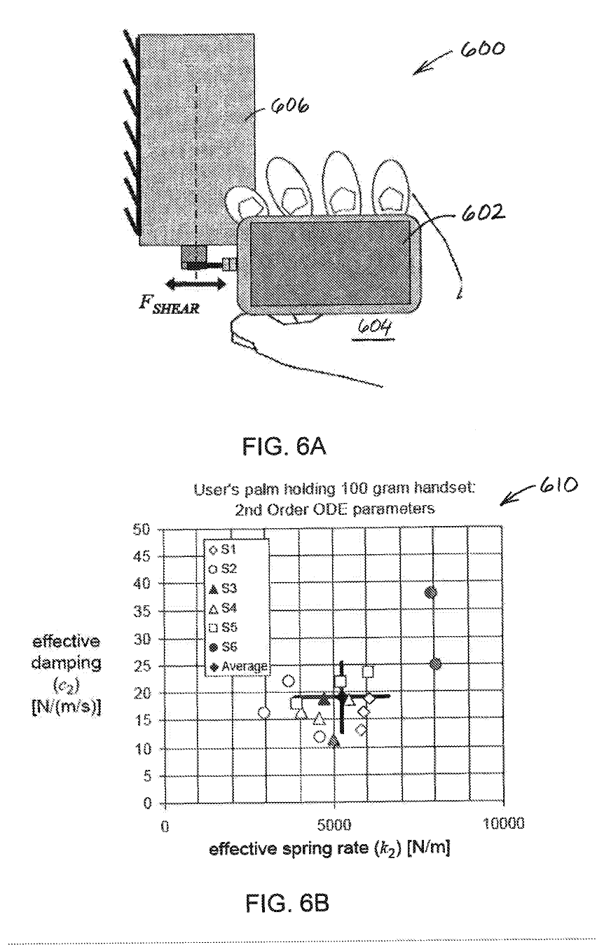

FIG. 6A is a top view showing a test setup 600 for measuring impedance of the palm 604. FIG. 6B Methods used for the palm 604 are similar to those used for the finger tip. In one aspect, in accordance with the present test procedure, subjects hold a 100 gram mobile device 602 (44×86×21 mm) in the palm 604 of the hand. Again, because only normal variability in service is of interest, in one aspect, the subjects' grasps do not have to be standardized. In other aspects, however, the subjects' grasps may be standardized. In one aspect, the test subjects may be simply asked to pretend they are about to press a key on a touchscreen. The mobile device 602 may be held in multiple ways. The mobile device 602 may be held as shown in FIG. 6A or may be rested on the palm 604. The mobile device 602 is attached to a dynamic force source 606 and frequency sweeps are applied as before. Only the spring rate and damping are estimated for the different palms 604 of the subjects, since effective mass of the palm is small compared to the test object. To get a sense of within-subject variation, subjects may re-grasp the mobile device 602 for one or more additional trials.

FIG. 6B is a graphical representation 610 of spring rate and damping of users' palms in multiple grasps. In particular, the graphical representation 610 of users' palms holding a 100 gram mobile handset and 2^{nd} order ODE parameters. Effective damping (c₂) in N/(m/s) is shown along the vertical axis and effective spring rate (k₂) in N/m is shown along the horizontal axis. The average values are bracketed by bars showing one standard deviation. For the palm 604, the average spring rate k₂ is 5244±1399 N/m, and the average damping coefficient c₂ was 19.0±6.4 N/(m/s).

### Actuator Design Constraints

In general, an electroactive polymer actuator has a significant number of independent variables. However, when external requirements influence the range of these independent variables, many of the variables become defined and designers are left with only a few adjustable parameters. The challenge is to adjust these few parameters to create a design that is both functional and economical.

Voltage is a critical design constraint for electroactive polymer actuators. Laboratory investigations of electroactive polymer actuators have required significant voltages to operate, typically 2-5 kilovolts. Hand held mobile devices are space-constrained and require compact electronics. Accordingly, AMI has developed materials and manufacturing processes that enable operation at 1 kV. Circuit designs have been completed that meet volume requirements. Future materials may bring operating voltages down to a few hundred volts, but for this design a maximum operating voltage of 1000 volts was set.

Another design constraint for any actuator is volume. Both footprint and height are precious to mobile device designers and minimizing actuator volume is critical. However, a given volume must be allocated and it is the actuator designers' responsibility to optimize within it. For this particular case an actuator footprint of 36 mm by 76 mm was set and an actuator height of 0.5 mm was set. Within this footprint, regions can be allocated to rigid frame or working dielectric. Actuator performance can be tuned by adjusting this allocation, and a method for doing so is presented next.

### Segmentation Method

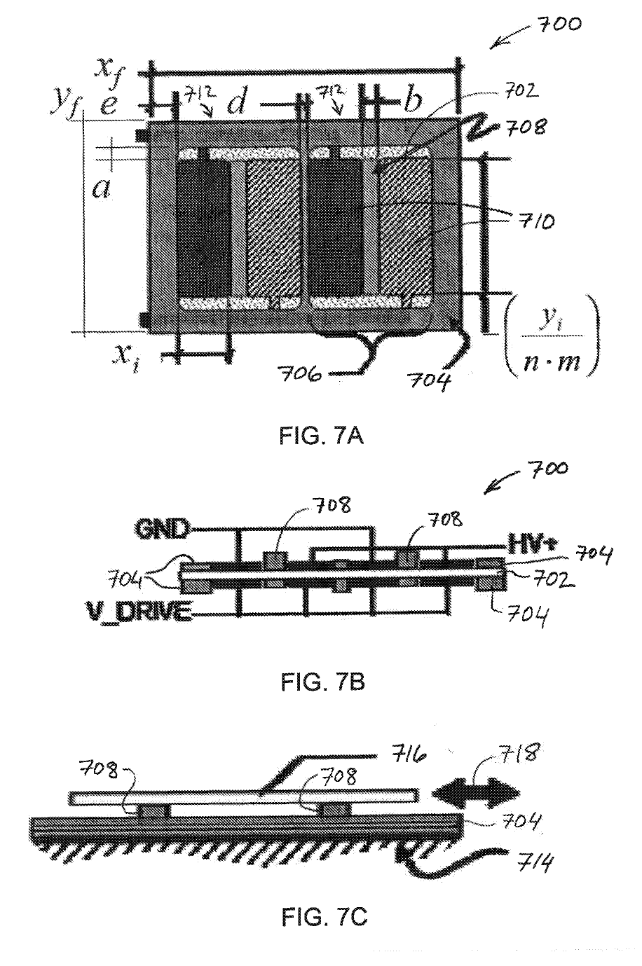

FIG. 7A illustrates one aspect of a segmented actuator 700 configured in a bar array geometry. Segmenting the actuator 700 within a given footprint into (n) sections provides a method for setting the passive stiffness and blocked force of the system. A pre-stretched dielectric elastomer 702 is held in place by a rigid material that defines an external frame 704 and one or more windows 706 within the frame 704. Inside each window 706 is a bar 708 of the same rigid frame material, and on one or both sides of the bar 708 are electrodes 710. Applying a potential difference across the dielectric elastomer 702 on one side of the bar 708 creates electrostatic pressure in the elastomer and this pressure exerts force on the bar 708, as described, for example, by Pelrine, R. E., Kornbluh, R. D. and Joseph, J. P., “Electrostriction Of Polymer Dielectrics With Compliant Electrodes As A Means Of Actuation,” Sensors and Actuators A 64, 77-85 (1998). The force on the bar 708 scales with the effective cross section of the actuator 700, and therefore increases linearly with the number of segments 712, each of which adds to the width (yᵢ). The passive spring rate scales with n², since each additional segment 712 effectively stiffens the actuator 700 device twice, first by shortening it in the stretching direction (xᵢ) and second by adding to the width (yᵢ) that resists displacement. Both spring rate and blocked force scale linearly with the number of dielectric layers (m).

FIG. 7B is a side view of the segmented actuator 700 shown in FIG. 7A that illustrates one aspect of an electrical arrangement of the phases with respect to the frame 704 and bars 708 elements of the actuator 700. FIG. 7C is a side view illustrating the mechanical coupling of the frame 704 to a backplane 714 and the bars 708 to an output plate 716.

With reference now to FIGS. 7A-C, segmenting the actuator 700 determines the effective rest length (xᵢ) of the composite segmented actuator 700 in the actuation direction 718, and the effective width (yᵢ) of the composite segmented actuator 700 according to:

$${x}_{i} = \frac{( {x}_{f} - ( 2 e + ( n - 1 ) d + nb ) )}{2 n} and \\ {y}_{i} = nm ( {y}_{f} - 2 ( e + a ) ) \qquad ( 1 )$$

where:

x_{f} is the footprint in the x-direction;

y_{f} is the footprint in the y-direction;

d is the width of the dividers;

e is the width of the edges;

n is the number of segments;

b is the width of the bars;

a is the bar setback; and

m is the number of layers.

Simulation data in accordance with the present disclosure are based on d=1.5 mm dividers, b=2 mm bars, a=5 mm edges, x_{f}=76 mm x_footprint, and y_{f}=36 mm y_footprint. Other values related to the dielectric and geometry include, for example, shear modulus G, dielectric constant ∈, un-stretched thickness z₀, the number of layers m, and the bar setback a.

FIGS. 7D-G illustrate examples of segmenting the footprint into n=7, 6, 5, 4 segments, respectively. In particular, FIG. 7D illustrates a segmented electrode 720 with a seven-segment footprint. FIG. 7E illustrates a segmented electrode 730 with a six-segment footprint. FIG. 7F illustrates a segmented electrode 740 with a five-segment footprint. FIG. 7G illustrates a segmented electrode 750 with a four-segment footprint.

### Strain Energy Model of Actuator Performance

The following description still references FIGS. 7A-C, which illustrates one aspect of a segmented actuator 700 design. For incompressible dielectric materials that can be described with a Neo-Hookean hyperelastic model, an energy balance method makes good predictions of actuator performance. The dielectric material is given an equibiaxial pre-stretch and then mechanically constrained using a frame 704 structure. Along with the dielectric material properties, both the pre-stretch and the frame 704 geometry determine the performance of the actuator 700. An energy model is now described to account for the effects of both material and geometry.

The Neo-Hookean strain energy density depends on the shear modulus and the three principal stretches in the dielectric elastomer:

$$W ( F ) = \frac{G}{2} \cdot [ {( {λ}_{1} )}^{2} + {( {λ}_{2} )}^{2} + {( {λ}_{3} )}^{2} - 3 ] \qquad ( 2 )$$

where:

G is the shear modulus; and

λ₁, λ₂, and λ₃ are the principle stretches in the dielectric elastomer.

To describe a particular actuator, the energy density (Joule/m³) is converted to an energy (Joule). Multiplying the strain energy density by the volume of material captured between the actuator frame 704 and the output bar 708 gives the elastic energy w stored in each half of the actuator 700. The energy depends on the initial volume and stretch in the material:

$$w ( {λ}_{i} ) = [ {x}_{0} \cdot {y}_{0} \cdot {z}_{0} ] \cdot \frac{G}{2} \cdot [ {( {λ}_{1} )}^{2} + {( {λ}_{2} )}^{2} + {( {λ}_{3} )}^{2} - 3 ] \qquad ( 3 )$$

where (x₀·y₀·z₀) is the volume of dielectric;

G is the shear modulus; and

λ₁, λ₂, and λ₃ are the three principal stretches in the dielectric.

As used herein, the term stretch has the usual meaning of stretched length compared to relaxed length (l/l₀). Rewriting this in terms of relative actuator displacement x and equibiaxial pre-stretch p gives an actuator energy that depends on displacement. For the geometry of the actuator 700 in the haptic module shown in FIGS. 7A-C, which moves a distance x from an initial pre-stretched length xᵢ this yields:

$$w ( x ) = [ \frac{{x}_{i}}{p} \cdot \frac{{y}_{i}}{p} \cdot {z}_{0} ] \cdot \frac{G}{2} \cdot [ {( p \cdot ( 1 + \frac{x}{{x}_{i}} ) )}^{2} + {( p )}^{2} + {( \frac{1}{{p}^{2} \cdot ( 1 + \frac{x}{{x}_{i}} )} )}^{2} - 3 ] \qquad ( 4 )$$

where:

p is the pre-stretch coefficient.

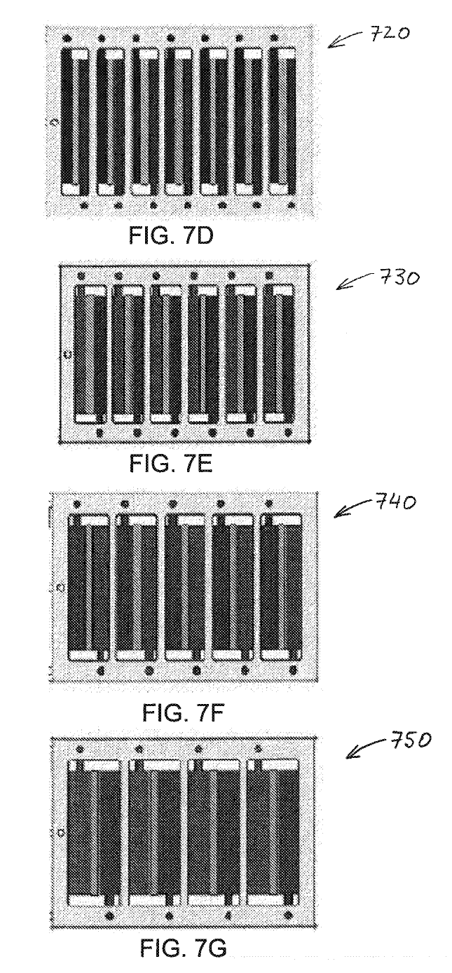

Still with reference to FIGS. 7A-C, for a symmetrical actuator 700, the stored elastic energy in each half of the actuator is a function of relative displacement of the output bar 708 and can be calculated using expression (4), and may be plotted for a given geometry and shear modulus as shown in FIG. 8A, for example. The minimum energy on one side occurs when displacement of the bar 708 relaxes the pre-stretch. It is not zero because the pre-stretch is biaxial, and the transverse component remains. The force that each half of the actuator 700 exerts on the output bar is obtained by differentiating the stored energy w with respect to displacement x. The force is given by:

$${F}_{ELASTIC} ( x ) = [ \frac{{x}_{i}}{p} \cdot \frac{{y}_{i}}{p} \cdot {z}_{0} ] \cdot G \cdot [ {p}^{2} \cdot \frac{( 1 + \frac{x}{{x}_{i}} )}{{x}_{i}} - \frac{1}{{p}^{4} \cdot ( {( 1 + \frac{x}{{x}_{i}} )}^{3} \cdot {x}_{i} )} ] \qquad ( 5 )$$

FIGS. 8A-C are graphical representations of strain, force, and voltage versus displacement of a symmetrical actuator in accordance with the present disclosure. FIG. 8A is a graphical representation 800 of strain energy versus displacement of a symmetrical actuator calculated for dielectric on one side of the actuator where strain energy in Joules (J) is shown along the vertical axis and displacement in meters (m) is shown along the horizontal axis.

FIG. 8B is a graphical representation 810 of elastic forces versus displacement of a symmetrical actuator calculated where force in Newtons (N) is shown along the vertical axis and displacement in meters (m) is shown along the horizontal axis. A plot of force versus displacement for each actuator half illustrates this relationship. The net elastic force on the output bar is the difference between the two forces on either side of actuator output bar

(F_{ELASTIC, a}−F_{ELASTIC, b}). In the case of a symmetrical actuator, this differential force is actually quite linear and is also plotted.

Adding a pair of compliant electrodes to the dielectric on one or both sides of the bar creates an electrically controlled actuator. Applying a potential difference across the dielectric creates an electrostatic pressure within the elastomer. This electrostatic pressure exerts a force on the output bar that acts in the desired output direction. The force as a function of displacement must produce work sufficient to balance change in electrical energy. For this geometry that balance yields:

$${F}_{ELEC} ( V , x ) = 0.5 \cdot {V}^{2} \frac{\partial C ( x )}{\partial x} , where \\ C ( x ) = {ɛɛ}_{0} \frac{{y}_{i} ( {x}_{i} + x )}{( \frac{{z}_{0}}{{p}^{2}} ) ( \frac{{x}_{i}}{{x}_{i} + x} )} \qquad ( 6 )$$

where;

V is voltage;

C is Capacitance;

∈ₒ is permittivity of free space;

∈ is relative dielectric constant.

Differentiating this equation gives the relatively instantaneous force:

$${F}_{ELEC} ( V , x ) = {V}^{2} \cdot \frac{{ɛ}_{0} \cdot {ɛ}_{r} \cdot {y}_{i} \cdot {p}^{2} \cdot ( {x}_{i} + x )}{{z}_{0} \cdot {x}_{i}} . \qquad ( 7 )$$

FIG. 8C is a graphical representation 820 of voltage versus displacement of a symmetrical actuator where Voltage (V) is shown along the vertical axis and displacement, x, in meters (m) is shown along the horizontal axis. Voltage adds an electrostatic force to the balance that displaces equilibrium to a new position. The instantaneous force that the dielectric exerts on the output bars is simply due to the elastic forces on both sides, and the electrostatic force (F_{ELASTIC,a}−F_{ELASTIC,b}+F_{ELEC}). For the static case without an external load, an equilibrium position exists. However, a closed form solution for this displacement as a function of voltage does not exist. A closed form solution does exist for calculating the required voltage as a function of displacement, and is plotted in FIG. 8C.

### Calibrating the Actuator Model to Dynamic Measurements

The method above provides a good baseline for actuator stiffness and force. It does not, however, provide a good model for damping. To properly predict performance, accurate damping models must be added. Damping terms for actuators can range from linear velocity-dependant loss to non-linear viscous damping dependant on higher order velocity terms, as described by Woodson, H. H., Melcher, J. R., “Electromechanical Dynamics,” John Wiley and Sons, New York, 60-88 (1969). For this model, only first and second order velocity damping terms were considered (FIG. 3, c₃, c_{q3}). Coulomb friction terms were ignored because AMI modules use ball bearings that make friction negligible compared to velocity-dependent damping sources.

A few similar actuator designs were tested and the data were fit to an actuator model. The linear damping term was small (less than 10%) compared to the quadratic damping term in the frequency range of interest. The quadratic damping term was roughly independent of the number of segments, because the total amount of actuated dielectric was roughly constant across design variations.

Sensation Transfer Function

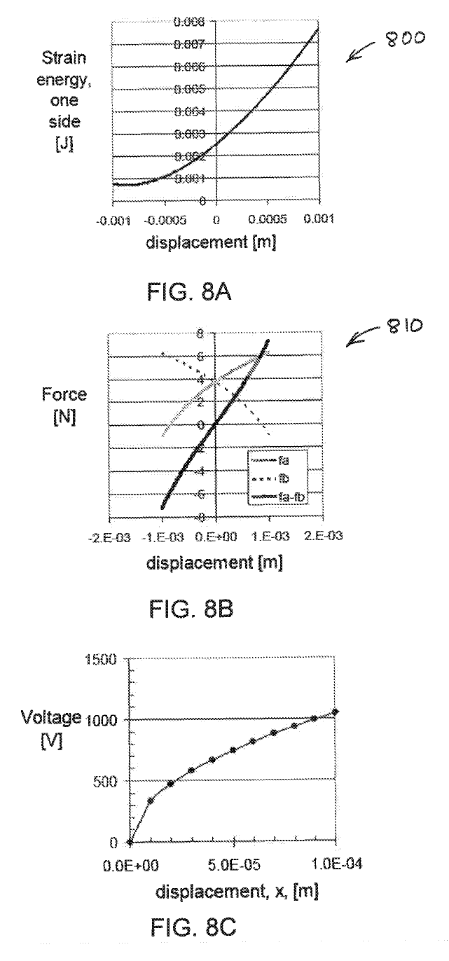

FIG. 9 is a graphical representation 900 of sensation level predicted from displacement and frequency. Displacement in decibels re 1 micron peak is shown along the vertical axis and frequency in Hertz is shown along the horizontal axis. The output of the transfer function is plotted for four sensation levels, {♦=20, ▪=30, ▴=40, =50} dB, superimposed on data from Verrillo, R. T., Fraioli, A. J. and Smith, R. L., “Sensation Magnitude Of Vibrotactile Stimuli,” Perception & Psychophysics 6, 366-372 (1969). Since fingertip-specific and palm-specific reports of sensitivity to shear vibrations of different frequencies and amplitudes were unavailable, measurements based on normal vibrations applied to the fleshy pad at the base of the thumb adapted from Verillo were relied on. It will be appreciated that this approach is preferable to an approach that ignores entirely the strong frequency dependence of human touch.

Parameters in a five-term expression were fit to these data, creating a transfer function. The input to the transfer function is mechanical displacement of a given amplitude and frequency. The output is an estimate of the strength of the user's sensation (S). Over the region of interest for haptic displays, (20-55 dB, 30-250 Hz), the fit matches sensation data within 5%. The expression has the form:

S=c₀+c₁(20 log₁₀(A))+c₂f+c₃f²+c₄f³ (8)

Where S is the user sensation level in decibels compared to threshold (0.1 μm at 250 Hz), f is frequency in Hertz, and A is the amplitude of the vibration in microns. Parameters are c₀=−18, c₁=1.06, c₂=0.34, c₃=−8.16E-4, c₄=−2.34E-7.

### Implementing The Model

The passive spring rate, related to (EQ. 5), and the blocked force (EQ. 7) were calculated in a spreadsheet (e.g., MicroSoft® Excel). Least squares fits to the palm and fingertip measurements were also made in Excel. Additional actuator stiffness due to dielectric between the ends of the bars and the edges of the frame was estimated by finite element analysis using a simulation environment such as COMSOL Multiphysics®, which is a simulation software environment that facilitates all steps in the modeling process—defining geometry, meshing, specifying physics, solving, and then visualizing results. The dynamics of the actuators were simulated in a simulation environment such as SPICE or PSPICE using an admittance analog for the mechanical components, where SPICE and PSPICE are simulation software for analog and digital logic circuits.

### Steady State Response—Gaming Capability

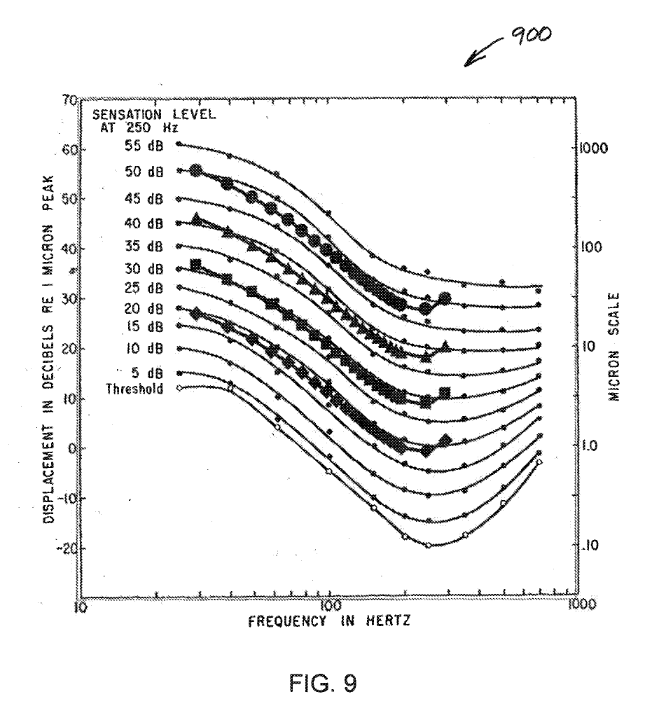

FIGS. 10A-D are graphical representations of predicted amplitude and sensation versus frequency. FIG. 10A is a graphical representation 1000 of predicted steady state amplitude associated with segmenting the footprint into (n) regions, where n=1 . . . 10, (circles) for the palm. FIG. 10B is a graphical representation 1010 of predicted steady state amplitude associated with segmenting the footprint into (n) regions, where n=1 . . . 10, (circles) for the fingertip. The design with six segments (bold traces) was manufactured and tested. FIG. 10C is a graphical representation 1020 of steady state sensations for the palm. FIG. 10D is a graphical representation 1030 of steady state sensations for the fingertip.

With reference now to FIGS. 10A-D, the model predicted that steady state amplitude would be maximized by segmenting the actuator into two parts (FIGS. 10A-B), but that this geometry would not maximize sensation (FIG. 10C-D).

The model predicted that a ten-segment actuator design would produce the maximum sensation, at 190 Hz, but at a substantial loss in low frequency sensation. Since gaming capability depends on those lower frequencies between 50 Hz and 100 Hz, a six-segment design was selected to compromise between peak intensity and strong bass for gaming and music.

### Transient Response—Click Capability

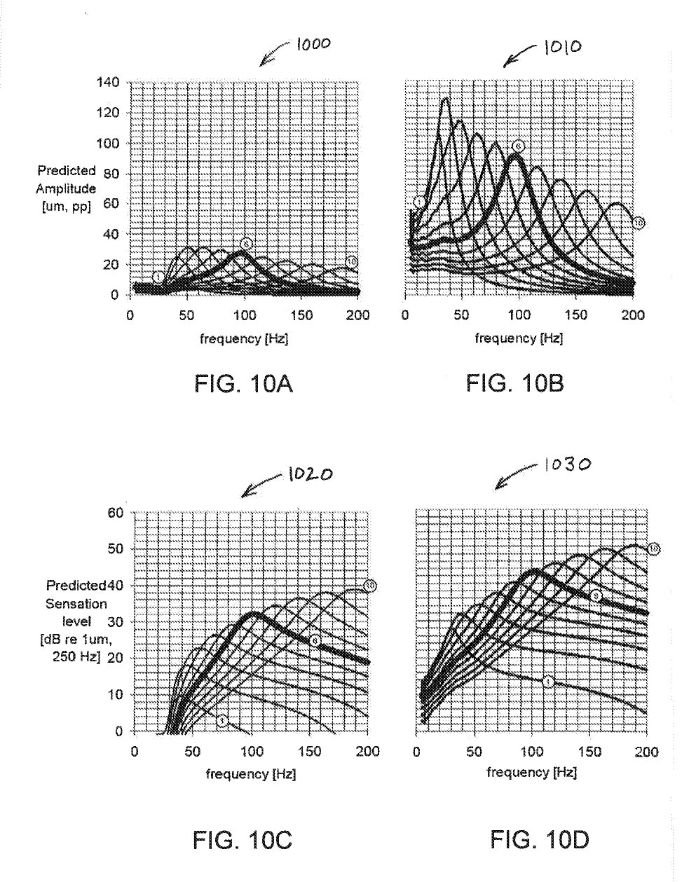

FIG. 11A is a graphical representation 1100 of predicted click amplitude that a candidate module could provide in service for the palm and fingertip. Amplitude in μm, pp is shown along the vertical axis and Frequency in Hertz (Hz) is shown along the horizontal axis. FIG. 11B is a graphical representation 1110 of predicted click sensation that a candidate module could provide in service for the palm and fingertip. Sensation in dB where 0 db is 1 μm at 250 Hz, is shown along the vertical axis and Frequency in Hertz (Hz) is shown along the horizontal axis. To evaluate the click capability offered by candidate designs, full voltage pulses were simulated. Duration of the pulse was one-quarter cycle of the resonant frequency, which varied depending on the design. Peak displacements were converted into estimates of sensation level. Results were similar to those for steady state—more segments decreased amplitude, but increased sensation.

### Measured Module Performance Versus Modeled

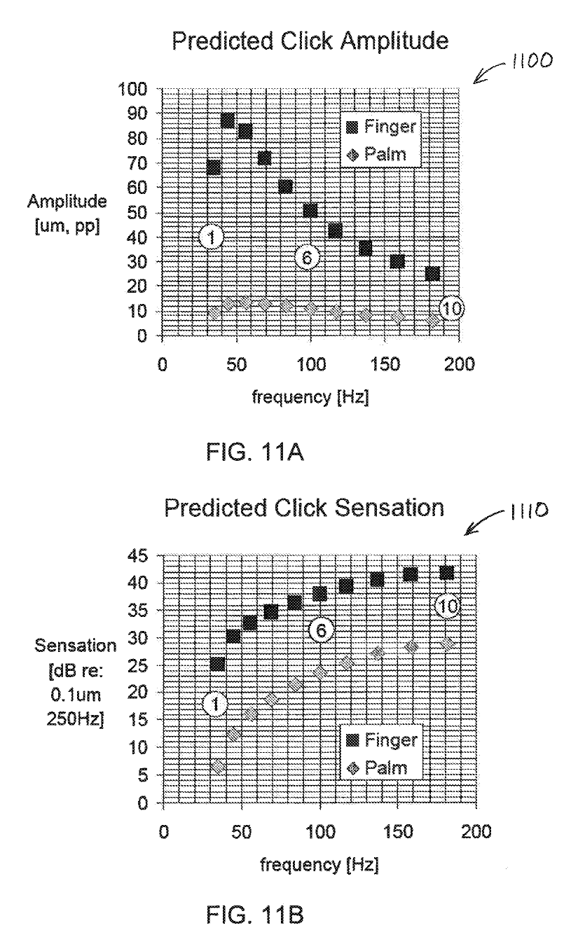

FIG. 12 is a graphical representation 1200 of steady state response of the module with a test mass was measured on the bench top, modeled (line) versus measured (points). A six-segment actuator design was selected for production because it offered a reasonable tradeoff between steady state gaming capability (FIG. 10) and click capability (FIG. 11). The steady state response of the six-segment actuator module with a test mass was measured on the bench (FIG. 12, points), and showed good agreement with the system model (FIG. 12, line). Amplitude on the bench exceeded simulation amplitude (FIG. 10) because bench testing eliminated stiffness, damping, and relative movement of the palm and fingertip.

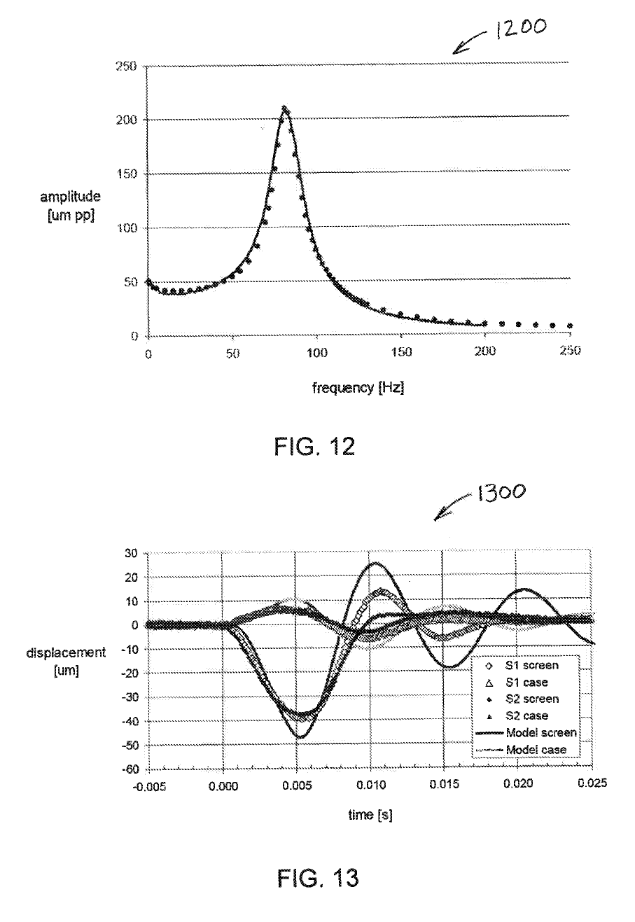

FIG. 13 is a graphical representation 1300 of observed click data for two users (points), and predictions of the model for an average user (lines). Displacement in micrometers (μm) is shown along the vertical axis and Time in seconds (s) is shown along the horizontal axis. To assess the ability of the model to predict click capability of the module in service, two users tested a handset mockup. Each user held the “handset” (a ˜100 gram test mass) as they had during calibration. Mounted on the test mass was a haptic module, and mounted on the module was a second ˜25 gram mass, approximating the “screen.” The user touched the “screen” with a fingertip and ˜0.5 N press force, approximating a key press. A voltage pulse was applied to the module for 0.004 seconds, (approximately a quarter-cycle of the resonance of the modeled system). Displacement of the “phone” and “screen” (FIG. 13, points) were tracked with a laser displacement meter (Keyence, LK-G152). As shown (FIG. 13, lines) the model gave a reasonable estimate of the click transient these two users experienced as they touched the screen while supporting the phone case in the palm. It appears that these two grasps had lower spring rates and higher damping ratios than the model did as would be appreciated by those skilled in the art. The model was based on average values, and individual spring rates and damping coefficients varied substantially, even between grasps by the same subject (FIG. 6).

### AMI Module Performance Versus Various Competing Haptic Technologies

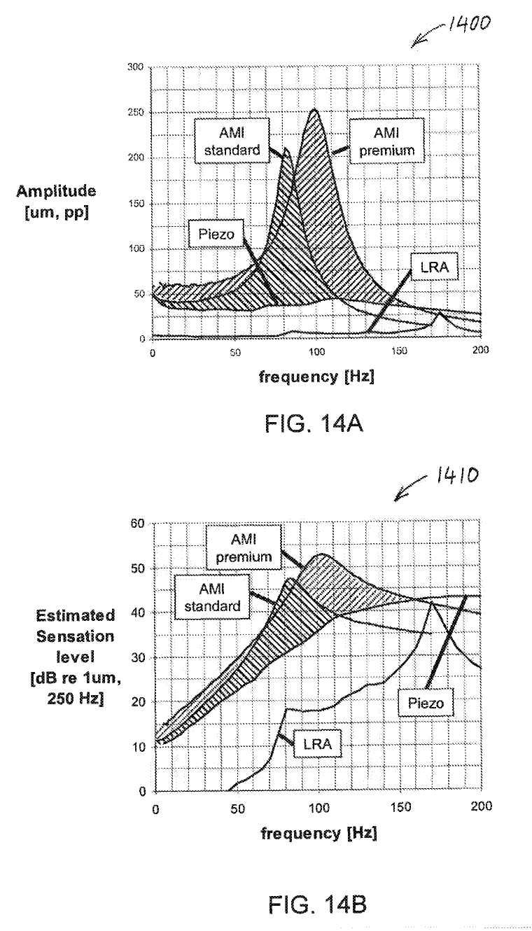

FIG. 14A is a graphical representation 1400 of amplitude versus frequency for various competing haptic technologies. Amplitude in microns (μm, pp) is shown along the vertical axis and Frequency in Hertz (Hz) is shown along the horizontal axis. FIG. 14B is a graphical representation 1410 of estimated sensation level versus frequency for various competing haptic technologies. Estimated sensation level (dB re 1 μm, 250 Hz) is shown along the vertical axis and Frequency in Hertz (Hz) is shown along the horizontal axis. Estimated sensations at these amplitudes and frequencies are shown. With reference to FIGS. 14A-B, bench testing of two AMI actuators driving a 20 gram test mass, and two commercially available actuators vibrating the handset screen (piezo), or case (LRA). Performance margins of standard and premium AMI modules are shaded. To put AMI haptic modules in commercial context, the steady state response was measured of two off-the-shelf handsets driven by other technologies—piezoceramic benders in one, and a linear resonant actuator (LRA) in another. The measurements were bench top tests, not handheld, since this is how module integrators currently assess them. For the piezo-driven handset, screen displacement was measured with the case fixed to the bench. The LRA-driven handset came with a testing protocol that we followed. Per protocol, the case displacement was tracked as the handset rested on a foam block.

A complete system model of one aspect of a mobile haptic device has been presented. The model includes many aspects that apply in general to haptic devices and are agnostic about actuator technology. The system model makes it possible to design a module that will deliver the desired capability in service. The trade off between click response and low-frequency gaming response becomes clear. The designer can design for what matters—performance of the handset in the hand, not just performance of the module on the bench. It has been challenging in the past to get from “that feels good” to something quantifiable. The analysis presented here is a start on solving that problem.

EPAM actuators can be constructed in a variety of different geometries that allow the designer to trade off blocked force and free stroke. In applications where the requirements are well defined (valves or pumps for instance) the designer's choice is straightforward. In applications like haptics, however, not only blocked force and free stroke are important. Other system responses including resonant frequency, damping, and transient response have interrelated effects on the end result (i.e., user perception), and a complete system model is important to help guide system design.

In the case of AMI modules, the design optimization produced a haptic system that can replicate crisp key presses, intense gaming effects, and vibration to signal an incoming call that eliminates the need for an LRA. Transforming the system response into estimated sensation significantly altered the design picture, and influenced design decisions.

Further improvements of the disclosed model could be adapted to other modes of operation, for example thumb typing and multi-touch systems, and all such improvements are within the scope of the present disclosure and appended claims. Also, capacitive touch screens and force sensing technologies are reducing the required amount of force to detect a touch and may lead to revised finger models.

Additional improvements on user sensation also are within the scope of the present disclosure and appended claims. Although the disclosed aspects of the model provide a method of transforming displacement into estimated sensation, the relative effectiveness of tangential versus normal displacement is also within the scope of the present disclosure and appended claims. Initial measurements of tangential sensitivity, for example, can be extended to more frequencies and amplitudes, as described in Israr, A., Choi, S. and Tan, H. Z., “Mechanical Impedance of the Hand Holding a Spherical Tool at Threshold and Suprathreshold Stimulation Levels,” Proceedings of the Second Joint EuroHaptics Conference and Symposium on Haptic Interfaces for Virtual Environment and Teleoperator Systems, 55-60 (2007); Ulrich, C. and Cruz, M., “Haptics: Perception, Devices and Scenarios,” Springer, Berlin & Heidelberg, 331-336 (2008); and Biggs, J., and Srinivasan, M. A., “Tangential Versus Normal Displacement Of Skin: Relative Effectiveness For Producing Tactile Sensation,” Proceedings 10th Symposium on Haptic Interfaces for Virtual Environments and Teleoperator Systems, 121-128 (2002).

Sensitivity to very brief click pulses, (e.g., one to three cycles), also is considered to be within the scope of the present specification and appended claims. The relative contribution of the palm versus the fingertip to sensation in handsets is also considered to be within the scope of the present specification and appended claims. Testing specific haptic effects on users is a further step. Designing for capability can insure that the user interface designer has a nimble and powerful instrument on which to play haptic effects. User testing facilitates the creation of effects that are both useful and pleasant as described in Koskinen, E., “Optimizing Tactile Feedback for Virtual Buttons in Mobile Devices, Masters Thesis,” Helsinki University (2008).

The standard AMI module has the desired advantage in gaming capability (50-100 Hz range), and can deliver strong bass effects for music. Because it provides higher peak sensation than the piezo or LRA, it is also suitable for silent notification of incoming calls. The standard module provides these advantages at moderate cost. For applications with the need and budget for extreme haptic effects, AMI also makes a premium module with additional layers of dielectric and additional capability.

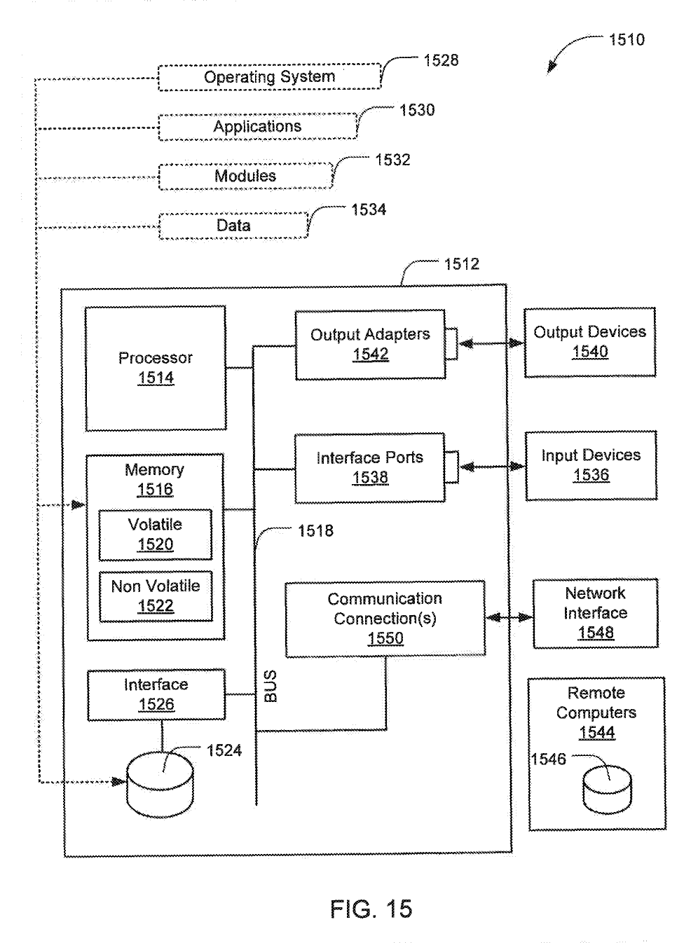

Having described the computer-implemented process for quantifying the capability of a haptic apparatus in general terms, the disclosure now turns to one non-limiting example of a computer environment in which the process may be implemented. FIG. 15 illustrates an example environment 1510 for implementing various aspects of the computer-implemented method for quantifying the capability of a haptic apparatus. A computer system 1512 includes a processor 1514, a system memory 1516, and a system bus 1518. The system bus 1518 couples system components including, but not limited to, the system memory 1516 to the processor 1514. The processor 1514 can be any of various available processors. Dual microprocessors and other multiprocessor architectures also can be employed as the processor 1514.

The system bus 1518 can be any of several types of bus structure(s) including the memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), Small Computer Systems Interface (SCSI) or other proprietary bus.

The system memory 1516 includes volatile memory 1520 and nonvolatile memory 1522. The basic input/output system (BIOS), containing the basic routines to transfer information between elements within the computer system 1512, such as during start-up, is stored in nonvolatile memory 1522. For example, the nonvolatile memory 1522 can include read only memory (ROM), programmable ROM (PROM), electrically programmable ROM (EPROM), electrically erasable ROM (EEPROM), or flash memory. Volatile memory 1520 includes random access memory (RAM), which acts as external cache memory. Moreover, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The computer system 1512 also includes removable/non-removable, volatile/non-volatile computer storage media. FIG. 15 illustrates, for example a disk storage 1524. The disk storage 1524 includes, but is not limited to, devices like a magnetic disk drive, floppy disk drive, tape drive, Jaz drive, Zip drive, LS-60 drive, flash memory card, or memory stick. In addition, the disk storage 1524 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1524 to the system bus 1518, a removable or non-removable interface 1526 is typically used.

It is to be appreciated that FIG. 15 describes software that acts as an intermediary between users and the basic computer resources described in a suitable operating environment 1510. Such software includes an operating system 1528. The operating system 1528, which can be stored on the disk storage 1524, acts to control and allocate resources of the computer system 1512. System applications 1530 take advantage of the management of resources by the operating system 1528 through program modules 1532 and program data 1534 stored either in the system memory 1516 or on the disk storage 1524. It is to be appreciated that various components described herein can be implemented with various operating systems or combinations of operating systems.

A user enters commands or information into the computer system 1512 through input device(s) 1536. The input devices 1536 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processor 1514 through the system bus 1518 via interface port(s) 1538. The interface port(s) 1538 include, for example, a serial port, a parallel port, a game port, and a universal serial bus (USB). The output device(s) 1540 use some of the same type of ports as input device(s) 1536. Thus, for example, a USB port may be used to provide input to the computer system 1512 and to output information from the computer system 1512 to an output device 1540. An output adapter 1542 is provided to illustrate that there are some output devices 1540 like monitors, speakers, and printers, among other output devices 1540 that require special adapters. The output adapters 1542 include, by way of illustration and not limitation, video and sound cards that provide a means of connection between the output device 1540 and the system bus 1518. It should be noted that other devices and/or systems of devices provide both input and output capabilities such as remote computer(s) 1544.

The computer system 1512 can operate in a networked environment using logical connections to one or more remote computers, such as the remote computer(s) 1544. The remote computer(s) 1544 can be a personal computer, a server, a router, a network PC, a workstation, a microprocessor based appliance, a peer device or other common network node and the like, and typically includes many or all of the elements described relative to the computer system 1512. For purposes of brevity, only a memory storage device 1546 is illustrated with the remote computer(s) 1544. The remote computer(s) 1544 is logically connected to the computer system 1512 through a network interface 1548 and then physically connected via a communication connection 1550. The network interface 1548 encompasses communication networks such as local-area networks (LAN) and wide area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

The communication connection(s) 1550 refers to the hardware/software employed to connect the network interface 1548 to the bus 1518. While the communication connection 1550 is shown for illustrative clarity inside the computer system 1512, it can also be external to the computer system 1512. The hardware/software necessary for connection to the network interface 1548 includes, for exemplary purposes only, internal and external technologies such as, modems including regular telephone grade modems, cable modems and DSL modems, ISDN adapters, and Ethernet cards.

As used herein, the terms “component,” “system” and the like can also refer to a computer-related entity, either hardware, a combination of hardware and software, software, or software in execution, in addition to electro-mechanical devices. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers. The word “exemplary” is used herein to mean serving as an example, instance, or illustration. Any aspect or design described herein as “exemplary” is not necessarily to be construed as preferred or advantageous over other aspects or designs.

The various illustrative functional elements, logical blocks, program modules, and circuits described in connection with the aspects disclosed herein may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format.

The functions of the various functional elements, logical blocks, program modules, and circuits elements described in connection with the aspects disclosed herein may be performed through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, DSP hardware, read-only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The various functional elements, logical blocks, program modules, and circuits elements described in connection with the aspects disclosed herein may comprise a processing unit for executing software program instructions to provide computing and processing operations for the computer and the industrial controller. Although the processing unit may include a single processor architecture, it may be appreciated that any suitable processor architecture and/or any suitable number of processors in accordance with the described aspects. In one aspect, the processing unit may be implemented using a single integrated processor.

The functions of the various functional elements, logical blocks, program modules, and circuits elements described in connection with the aspects disclosed herein may be implemented in the general context of computer executable instructions, such as software, control modules, logic, and/or logic modules executed by the processing unit. Generally, software, control modules, logic, and/or logic modules include any software element arranged to perform particular operations. Software, control modules, logic, and/or logic modules can include routines, programs, objects, components, data structures and the like that perform particular tasks or implement particular abstract data types. An implementation of the software, control modules, logic, and/or logic modules and techniques may be stored on and/or transmitted across some form of computer-readable media. In this regard, computer-readable media can be any available medium or media useable to store information and accessible by a computing device. Some aspects also may be practiced in distributed computing environments where operations are performed by one or more remote processing devices that are linked through a communications network. In a distributed computing environment, software, control modules, logic, and/or logic modules may be located in both local and remote computer storage media including memory storage devices.

Additionally, it is to be appreciated that the aspects described herein illustrate example implementations, and that the functional elements, logical blocks, program modules, and circuits elements may be implemented in various other ways which are consistent with the described aspects. Furthermore, the operations performed by such functional elements, logical blocks, program modules, and circuits elements may be combined and/or separated for a given implementation and may be performed by a greater number or fewer number of components or program modules. As will be apparent to those of skill in the art upon reading the present disclosure, each of the individual aspects described and illustrated herein has discrete components and features which may be readily separated from or combined with the features of any of the other several aspects without departing from the scope of the present disclosure. Any recited method can be carried out in the order of events recited or in any other order which is logically possible.

It is worthy to note that any reference to “one aspect” or “an aspect” means that a particular feature, structure, or characteristic described in connection with the aspect is included in at least one aspect. The appearances of the phrase “in one aspect” or “in one aspect” in the specification are not necessarily all referring to the same aspect.

Unless specifically stated otherwise, it may be appreciated that terms such as “processing,” “computing,” “calculating,” “determining,” or the like, refer to the action and/or processes of a computer or computing system, or similar electronic computing device, such as a general purpose processor, a DSP, ASIC, FPGA or other programmable logic device, discrete gate or transistor logic, discrete hardware components, or any combination thereof designed to perform the functions described herein that manipulates and/or transforms data represented as physical quantities (e.g., electronic) within registers and/or memories into other data similarly represented as physical quantities within the memories, registers or other such information storage, transmission or display devices.

It is worthy to note that some aspects may be described using the expression “coupled” and “connected” along with their derivatives. These terms are not intended as synonyms for each other. For example, some aspects may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. With respect to software elements, for example, the term “coupled” may refer to interfaces, message interfaces, application program interface (API), exchanging messages, and so forth.

It will be appreciated that those skilled in the art will be able to devise various arrangements which, although not explicitly described or shown herein, embody the principles of the present disclosure and are included within the scope thereof. Furthermore, all examples and conditional language recited herein are principally intended to aid the reader in understanding the principles described in the present disclosure and the concepts contributed to furthering the art, and are to be construed as being without limitation to such specifically recited examples and conditions. Moreover, all statements herein reciting principles, aspects, and aspects as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present disclosure, therefore, is not intended to be limited to the exemplary aspects and aspects shown and described herein. Rather, the scope of present disclosure is embodied by the appended claims.

The terms “a” and “an” and “the” and similar referents used in the context of the present disclosure (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as,” “in the case,” “by way of example”) provided herein is intended merely to better illuminate the invention and does not pose a limitation on the scope of the invention otherwise claimed. No language in the specification should be construed as indicating any non-claimed element essential to the practice of the invention. It is further noted that the claims may be drafted to exclude any optional element. As such, this statement is intended to serve as antecedent basis for use of such exclusive terminology as solely, only and the like in connection with the recitation of claim elements, or use of a negative limitation.

Groupings of alternative elements or aspects disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

White certain features of the aspects have been illustrated as described above, many modifications, substitutions, changes and equivalents will now occur to those skilled in the art. It is therefore to be understood that the appended claims are intended to cover all such modifications and changes as fall within the scope of the disclosed aspects and appended claims.

What is claimed is:

1. A computer-implemented method of quantifying the capability of a haptic system, the haptic system comprising an actuator, the computer comprising a processor, a memory, and an input/output interface for receiving and transmitting information to and from the processor, the computer providing an environment for simulating the mechanics of the haptic system, determining the performance of the haptic system, and determining a user sensation produced by the haptic system in response to an input to the haptic system, the computer-implemented method comprising:
receiving an input command by a mechanical system module that simulates a haptic system, wherein the input command represents an input voltage applied to the haptic system;
producing a displacement by the mechanical system module in response to the input command;
receiving the displacement by an intensity perception module;
mapping the displacement to a sensation experienced by a user by the intensity perception module; and
producing the sensation experienced by the user in response to the input command.

2. The computer-implemented method of claim 1, wherein receiving an input command comprises receiving a steady state input voltage defined by an amplitude and a frequency.

3. The computer-implemented method of claim 2, wherein producing the sensation comprises producing a sensation which depends on the frequency and the amplitude of the steady state input voltage, wherein the sensation has an intensity expressed in decibels and describes a gaming/music capability of a haptic system design.

4. The computer-implemented method of claim 1, wherein receiving an input command comprises receiving a transient input voltage defined by an amplitude and a pulse width.

5. The computer-implemented method of claim 4, wherein producing the sensation comprises producing the sensations which depends on the amplitude and duration of the input transient input voltage, wherein the sensation has an intensity expressed in decibels, and describes a click capability of a haptic system design.

6. The computer-implemented method of claim 1, comprising simulating, by the mechanical system module, a fingertip applying an input pressure to the haptic system.

7. The computer-implemented method of claim 6, wherein simulating a fingertip applying an input pressure to the haptic system comprises:
measuring a steady state response to proximal/distal shear vibration produced by a fingertip during key press; and
estimating parameters of a fingertip model by applying the measured steady state response data to a mass-spring-damper system approximation of the fingertip.

8. The computer-implemented method of claim 1, comprising simulating, by the mechanical system module, a palm squeezing the haptic system.

9. The computer-implemented method of claim 8, wherein simulating the palm applying a squeezing pressure to the haptic system comprises:
measuring a steady state response to proximal/distal shear vibration produced by a palm squeezing the haptic system; and
estimating parameters of a palm model by applying the measured steady state response data to a mass-spring-damper system approximation of the palm.

10. The computer-implemented method of claim 1, comprising simulating, by the mechanical system module, an actuator of the haptic system as a force source in parallel with a spring and damper.

11. The computer-implemented method of claim 10, wherein simulating the actuator of the haptic system comprises segmenting the actuator within a predetermined footprint into a plurality of sections.

12. A segmented actuator for a haptic system, the segmented actuator comprising:
a pre-stretched dielectric elastomer coupled to a rigid frame;
at least one window within the rigid frame;
at least one bar formed inside the at least one window; and
at least one electrode disposed on at least one side of the at least one bar;
wherein applying a potential difference across the dielectric on the at least one side of the least one bar creates electrostatic pressure in the dielectric elastomer to exert a force on the at least one bar.

13. The segmented actuator of claim 12, wherein the bar is formed of the same rigid frame material.

14. The segmented actuator of claim 12, comprising a plurality of segments disposed within a predetermined footprint, wherein (x_{f}) is the footprint in the x-direction and (y_{f}) is the footprint in the y-direction.

15. The segmented actuator of claim 14, wherein the force on the at least one bar scales with an effective cross section of the segmented actuator, wherein the force increases linearly with the number of segments, each of which adds to the width (yᵢ) in the y-direction.

16. The segmented actuator of claim 14, wherein a passive spring rate of the actuator scales with the square of the number of segments, wherein each additional segment effectively stiffens the actuator first by shortening the actuator in the stretching direction (xᵢ) and second by adding to the width (yᵢ) that resists displacement.

17. The segmented actuator of claim 14, wherein the pre-stretched dielectric elastomer comprises a plurality of layers (m), wherein a spring rate and blocked force of the segmented actuator scale linearly with the number of dielectric layers (m).

18. A computer-implemented method of simulating a segmented actuator for a haptic system, the segmented actuator defined a plurality of segments (n); a pre-stretched dielectric elastomer coupled to a rigid frame, the pre-stretched dielectric elastomer comprising a plurality of layers (m); at least two windows within the rigid frame and a divider located between the at least two windows; at least one bar formed inside each window; at least one electrode disposed on at least one side of the at least one bar; a frame edge; and a footprint where x_{f} is the footprint in the x-direction and y_{f} is the footprint in the y-direction;
the computer comprising a processor, a memory, and an input/output interface for receiving and transmitting information to and from the processor, the computer providing an environment for simulating the segmented actuator for a haptic system;
the computer-implemented method comprising:
determining, by the processor, an effective rest length (xᵢ) of the segmented actuator in an actuation direction and an effective width (yᵢ) of the composite actuator;
determining, by the processor, a strain energy density of the segmented actuator
determining, by the processor, a stored elastic energy of the segmented electrode as a function of relative displacement of the output bar strain energy density;
determining, by the processor, the force that half of the segmented actuator exerts on the output bar; and
determining, by the processor, a force as a function of displacement to produce work sufficient to balance change in electrical energy when a potential difference is applied across the dielectric elastomer to create an electrostatic pressure within the elastomer, wherein the electrostatic pressure exerts the force on the bar that acts in a desired output direction.

19. The computer-implemented method of claim 18, comprising:
determining the effective rest length (xᵢ) of the segmented actuator in an actuation direction and the effective width (yᵢ) of the composite actuator according to the expressions:
$${x}_{i} = \frac{( {x}_{f} - ( 2 e + ( n - 1 ) d + nb ) )}{2 n}$$
$$and$$
$${y}_{i} = nm ( {y}_{f} - 2 ( e + a ) )$$
where:
x_{f} is the footprint in the x-direction;
y_{f} is the footprint in the y-direction;
d is the width of the divider;
e is the width of the frame edge;
n is the number of segments;
b is the width of the bar;
a is the bar setback; and
m is the number of layers.

20. The computer-implemented method of claim 18, comprising:
determining the strain energy density of the segmented actuator according to the expression:
$$W ( F ) = \frac{G}{2} \cdot [ {( {λ}_{1} )}^{2} + {( {λ}_{2} )}^{2} + {( {λ}_{3} )}^{2} - 3 ]$$
where:
G is the shear modulus; and
λ₁, λ₂, and λ₃ are the principle stretches in the dielectric elastomer.

21. The computer-implemented method of claim 18, comprising:
determining the stored elastic energy of the segmented electrode as a function of relative displacement of the bar strain energy density according to the expression:
$$w ( x ) = [ \frac{{x}_{i}}{p} \cdot \frac{{y}_{i}}{p} \cdot {z}_{0} ] \cdot \frac{G}{2} \cdot [ {( p \cdot ( 1 + \frac{x}{{x}_{i}} ) )}^{2} + {( p )}^{2} + {( \frac{1}{{p}^{2} \cdot ( 1 + \frac{x}{{x}_{i}} )} )}^{2} - 3 ]$$
where:
p is the pre-stretch coefficient.

22. The computer-implemented method of claim 18, comprising:
determining the force that half of the segmented actuator exerts on the bar according to the expression:
$${F}_{ELASTIC} ( x ) = [ \frac{{x}_{i}}{p} \cdot \frac{{y}_{i}}{p} \cdot {z}_{0} ] \cdot G \cdot [ {p}^{2} \cdot \frac{( 1 + \frac{x}{{x}_{i}} )}{{x}_{i}} - \frac{1}{{p}^{4} \cdot ( {( 1 + \frac{x}{{x}_{i}} )}^{3} \cdot {x}_{i} )} ] .$$

23. The computer-implemented method of claim 18, comprising:
determining the force as a function of displacement to produce work sufficient to balance change in electrical energy when a potential difference is applied across the dielectric elastomer to create an electrostatic pressure within the elastomer, wherein the electrostatic pressure exerts the force on the bar that acts in a desired output direction, wherein the force is determined according to the expression:
$${F}_{ELEC} ( V , x ) = 0.5 \cdot {V}^{2} \frac{\partial C ( x )}{\partial x}$$
$$and$$
$$C ( x ) = {ɛɛ}_{0} \frac{{y}_{i} ( {x}_{i} + x )}{( \frac{{z}_{0}}{{p}^{2}} ) ( \frac{{x}_{i}}{{x}_{i} + x} )}$$
where:
V is voltage;
C is Capacitance;
∈ᵣ is relative dielectric constant; and
∈ₒ is permittivity of free space.

24. The computer-implemented method of claim 23, comprising:
determining the instantaneous force as a function of displacement according to the expression:
$${F}_{ELEC} ( V , x ) = {V}^{2} \cdot \frac{{ɛ}_{0} \cdot {ɛ}_{r} \cdot {y}_{i} \cdot {p}^{2} \cdot ( {x}_{i} + x )}{{z}_{0} \cdot {x}_{i}} .$$
